(19) United States
(12) Patent Application Publication
(10) Pub. No.: US 2002/0167772 A1
(43) Pub. Date: Nov. 14, 2002

(54) Bridge rectifer for rotary current generators

(76) Inventors: Martin Haupt, Cowbridge (GB); Herbert Labitzke, Markgroeningen (DE); Walter Csicser, Schwieberdingen (DE); Klaus-Uwe Mittelstaedt, Weissach (DE); Holger Scholzen, Schwieberdingen (DE); Karl-Otto Heinz, Remseck (DE); Holger Haussmann, Metzingen (DE); Henning Stilke, Westermoor (DE); Hermann Lehnertz, Fellbach (DE)

Correspondence Address: Striker Striker & Stenby, 103 East Neck Road, Hungtington, NY, 11743, US

(21) Appl. No.: 09/913,973

(22) PCT Filed: Dec. 20, 2000
(86) PCT No.: PCT/DE00/04553

(30) Foreign Application Priority Data
Dec. 29, 1999 (DE) 199 63 627.3

(51) Int. Cl. H02H 5/04

(52) U.S. Cl. 361/104; 361/23

(57) ABSTRACT

The invention concerns a bridge rectifier for rotary current generators, in particular for supplying the electrical system of motor vehicles. It comprises rectifier diodes and a printed circuit board comprising an insulator (23) basically designed in the shape of a plate, in which multiple connection conductors (24) are embedded between the diodes of the rectifier bridges, whereby sections of these connection conductors are designed to be bent extending out of the insulator and as fuses (25) that melt in case of electrical overload. In order to achieve the smallest possible tolerances for operation of the fuses, each of the fuses (25) is formed out of two conductor ends (24a)-bent to the outside-of the connection conductors (24) and a fuse element (29) connected with them that bridges the conductor ends.

The invention concerns a bridge rectifier for rotary current generators, in particular for supplying the electrical system of motor vehicles according to the preamble of the primary claim.

### RELATED ART

Electrical devices are used to an increasing extent in motor vehicles to improve the comfort and safety of the motor vehicles. In the vast majority of cases, rotary generators that have a high power density and can therefore receive a strong thermal load are used to supply these devices in the electrical system of the motor vehicle. A rectifier arrangement is usually provided on the housing of the rotary generators, so that only its direct current output forms the terminals of the generator to which the connector cables of an accumulator battery of the motor vehicle electrical system are connected. In case of an overload or a short circuit at the generator or the rectifier arrangement-which occurs not uncommonly as a result of charging batteries using battery charging devices connected in an incorrectly polarized fashion-not only is the generator and/or the rectifier arrangement destroyed, but further thermal damage can be caused as well as a result.

To prevent these dangers, DE 30 01 522 C2 has already made known to provide fuses in the rectifier arrangement between the connections of the plus and minus diodes of the three rectifier bridges. They are formed out of conductor sections bent and extending in the shape of loops out of recesses in the printed circuit boards of the rectifier arrangment that melt in the case of electrical overload, but which can be repaired provisionally by twisting the ends. When a fuse is blown, therefore, the rectifier arrangement must be completely replaced later on. If this does not happen, the risk that the generator will be destroyed and the risk of subsequent damages increase quite considerably.

Due to the high power density in the bridge rectifier, it must be ensured, on the one hand, that the fuse does not blow too soon. On the other hand, the overload must also not become so great that the diodes burn out or the bonding sites melt off even before the fuse blows. With the known solution, however, the tolerances with the threshold current of the fuses formed by the conductor loops are so great due to the production tolerances that the fuses blow too soon in some cases and too late in other cases as a result of currents in the rectifier bridges.

With the present invention, the aim is to protect the generator and the bridge rectifier against electrical overload or short circuit in the narrowest possible tolerance range of the maximum permissible current.

Advantages of the Invention

The bridge rectifier according to the invention having the features of the primary claim described has the advantage that, as a result of appropriate material selection and an exact, simple cross-sectional sizing of the fuse element inserted between the conductor ends of the connecting conductors, the threshold value of the fuse can be kept within narrow tolerance limits, so that the bridge rectifier is to be designed for a correspondingly higher power density. A further disadvantage exists in the fact that, when a fuse is blown, the bridge rectifier can first be replaced and, by replacing the blown fuse element, it can be reused as a replacement rectifier.

Advantageous further developments and embodiments arise from the remaining features named in the subclaims. It has proven particularly advantageous for the production of the fuse, for example, that the fuse element be designed as a fuse strip, the ends of which are electrically connected with the conductor ends of the printed circuit board. For the replacement of a defective fuse element, it is particularly advantageous thereby to connect this with the conductor ends of the printed circuit board via clamping. A thermally and mechanically stable connection of the conductor ends of the printed circuit board with the fuse strips results from the fact that the fuse strip is soldered or welded to the flattened end sections of the connection conductors-comprised of round wire-of the printed circuit board.

In order to protect the sensitive fuse element against corrosion and damage from the outside, it is further proposed that each of the fuse elements be surrounded by a closed container and that the container be filled with silica sand. In order to protect the fuse elements against vibrations during operation, the containers are to be attached to the plate-shaped insulators of the printed circuit board in advantageous fashion.

### DRAWING

Further details of the invention are described in greater detail in the design example described below using the associated drawing.

FIG. 1 shows the circuitry of the rotary current generator with the bridge rectifier.

FIG. 2 shows a cross section through the structural layout of the bridge rectifier.

FIG. 3 shows a section of the printed circuit board of the bridge rectifier with the fuse element in an enlarged dimension from the side according to line A-A from FIG. 4.

FIG. 4 shows the same fuse element from the front in a container.

### DESCRIPTION OF THE DESIGN EXAMPLES

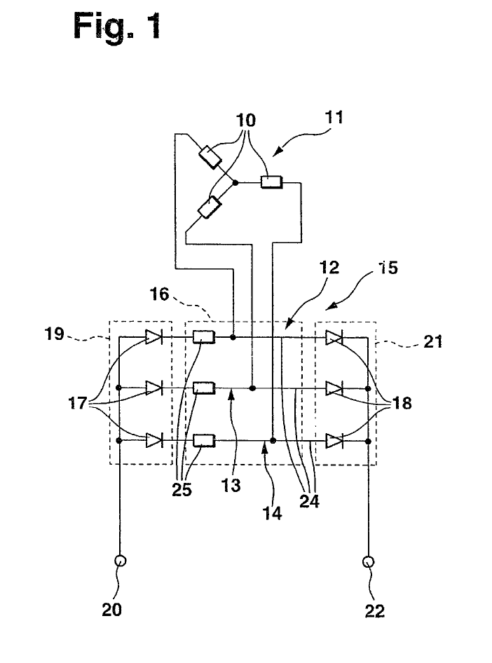

The three phases 10 of an alternating current generator 11 for motor vehicles are shown in FIG. 1, the one ends of each of which are combined in a wye connection, and each of the other ends of which is connected to a rectifier bridge 12, 13 and 14 of a bridge rectifier. A printed circuit board 16 serves to connect the three phases 10 with the three rectifier bridges, whereby each of the three rectifier bridges consists of a minus diode 17 and a plus diode 18 connected in series. The minus diodes 17 are pressed in a minus heat sink 19 on the anode side, and the anode terminals of the minus diodes 17 are therefore combined into one minus terminal 20 by way of the minus heat sink 19. The plus diodes 18 are pressed in a plus heat sink 21 on the cathode side. The cathode terminals of the plus diodes 17 are therefore combined in this heat sink 21 and are connected with a plus terminal 22 of the bridge rectifier 15.

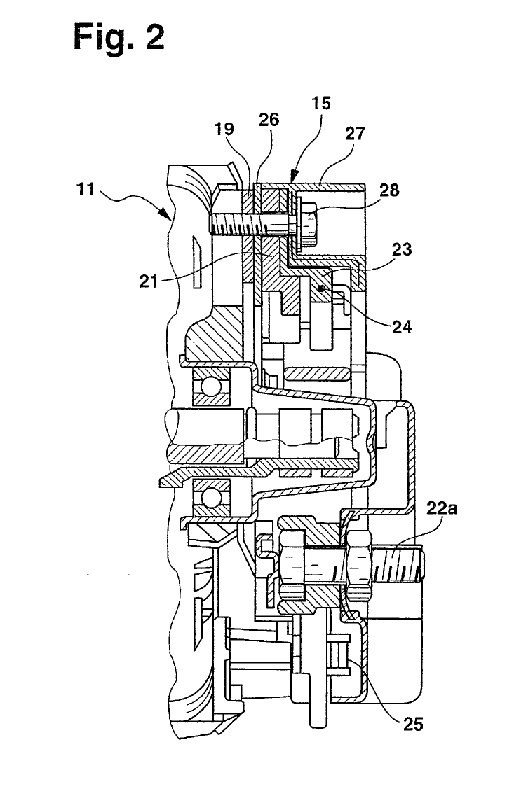

In conjunction with FIGS. 2 through 4 it is obvious that the printed circuit board 16 comprises an insulator 23 basically designed in the shape of a plate in which multiple connection conductors 24 are embedded that connect the plus and minus diodes 17, 18 of each rectifier bridge 12, 13 and 14 with each other and with the phases 10 of the rotary current generator. A fuse 25 is arranged in each rectifier bridge 12, 13 and 14 to protect the rotary current generator 11 and the diodes 17, 18. The fuses 25 are sized in such a way that they blow when the permissible maximum direct current is exceeded in the rectifier bridges 12, 13 and 14.

The bridge rectifier 15 is attached to the back side of the rotary current generator according to FIG. 2. Its structural design is such that, first, the minus heat sink 19 lies against the housing of the rotary current generator lying on frame potential. Following this is an insulation plate 26, then the plus heat sink 21, the printed circuit board 23 on top of that and, finally, a protective cap 27. These parts are attached to the generator using a screw 28. The plus terminal 22 is formed in this case by a connecting screw 22a inserted in the plus heat sink 21.

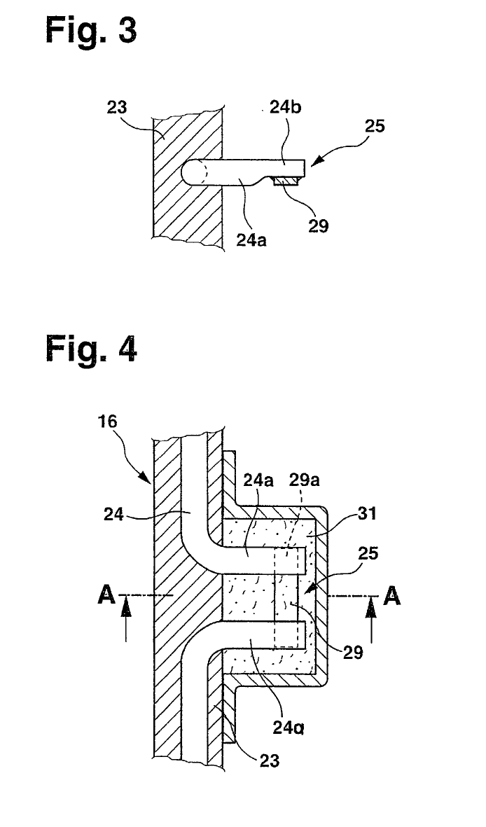

Each of the fuses 25 is formed according to FIGS. 3 and 4 out of two conductor ends 24a-bent to the outside-of the connection conductors 24 and a fuse element 29. The conductor ends 24a, as sections of the connection conductors 24, are bent out of the insulator 23 of the printed circuit board 16 at a right angle, so that they stand above the insulator 23. These conductor ends 24a are bridged by the fuse element 29 in the form of a metal strip in that the ends 29a of the fuse element 29 are electrically connected with the conductor ends 24a. In the example case, the ends 29a of the fuse element 26 are soldered to flattened end sections 24b of the connection conductors 24 consisting of round wire. If the spacial circumstances permit this, they can just as well be welded on. If necessary, the very sensitive fuse elements 29 can also be protected against corrosion or mechanical damage using a closed container according to FIG. 4 that completely surrounds the conductor ends 24a with the fuse element 29. The container 30 designed in the shape of a cup can thereby be produced in simple fashion out of a plastic and glued to the surface of the insulator 23 of the printed circuit board 16. The container 30 is also filled with silica sand 31 in order to keep short-term temperature changes from the outside away from the fuse element 29 and, therefore, to optimize the threshold behavior of the fuses 25.

Since, in most cases, both ends of the windings of the three phases 10 of the rotary current generator 11 are connected to the printed circuit board 16 of the bridge rectifier 15, the neutral point of the three phases 10 can also be protected using a fuse element 25. In this case, a further connection conductor 24 that connects the three phases 10 to a neutral point is embedded in the plate-shaped insulator 23 of the printed circuit board 16. A fuse 25 can also be provided in this connection conductor in similar fashion. The fuse element 29 can also be designed to be replaceable. In this case, the terminals of the fuse element are to be connected with the conductor ends 24a via clamping.

1. Bridge rectifier (15) for rotary current generators (11), in particular for supplying the electrical system of motor vehicles, comprising rectifier diodes (17,18) and a printed circuit board comprising an insulator (23) basically designed in the shape of a plate, in which multiple connection conductors (24) are embedded between the diodes of the rectifier bridges (12, 13, 14), whereby sections of these connection conductors extend out of the insulator and are designed as fuses (25) that melt in case of electrical overload, characterized in that each of the fuses (25) is formed out of two conductor ends (24a) bent to the outside and a fuse element (29) connected to them that bridges the conductor ends.

2. Bridge rectifier according to claim 1, characterized in that the fuse element (29) is a metal strip, the ends (29a) of which are electrically connected with the conductor ends (24a).

3. Bridge rectifier according to claim 1 or 2, characterized in that the fuse element (29) is connected with the conductor ends (24a) using clamps.

4. Bridge rectifier according to claim 2, characterized in that the fuse element (29) is soldered or welded to flattened end sections (24b) of connection conductors (24) consisting of round wire.

5. Bridge rectifier according to one of the claims 1 through 4, characterized in that each of the fuse elements (29) is surrounded by a container.

6. Bridge rectifier according to claim 5, characterized in that the containers (30) attached to the insulators (23) designed in the shape of a plate are preferably glued.

7. Bridge rectifier according to claim 5, characterized in that the containers (30) are filled with silica sand.
